(19) United States
(12) Patent Application Publication
(10) Pub. No.: US 2006/0158872 A1
(43) Pub. Date: Jul. 20, 2006

(54) Christmas tree with visual effect of crystal ice

(76) Inventor: Sheng-Wen Huang, Shenzhen (CN)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/039,580

(22) Filed: Jan. 20, 2005

(51) Int. Cl. F21S 6/00; A47G 33/06

(52) U.S. Cl. 362/123; 428/18

(57) ABSTRACT

A Christmas tree of the invention includes a trunk frame; a plurality of branch supports attached to the trunk frame; and a decorative layer enclosing the branch supports. The branch supports are attached to the trunk frame by a plurality of lock members. The decorative layer comprises a plurality of branches and petals connected with the branches. Each of the branches and the petals comprises an inner body, a color coating formed on the inner body, an adhesive layer formed on the color coating, and a plurality of transparent plastic grains bonded to the adhesive layer. Each of the branches and the petals has glitter powder distributed thereon. A plurality of decorative lamps are provided for enwinding on the branches.

### FIELD OF THE INVENTION

The present invention relates to exclusive Christmas trees with visual effect of crystal ice.

### BACKGROUND OF THE INVENTION

At present, there are many kinds of Christmas trees with metal frame, however a Christmas tree that have a visual effect of crystal ice has not been found in the market which is made by soft plastic materials.

### SUMMARY OF THE INVENTION

An main object of the invention is to provide a Christmas tree which have a visual effect of crystal ice.

Another object of the invention is to provide a Christmas tree which have a visual effect of tenderness.

A further object of the invention is to provide a Christmas tree which can shine at night to acquire a highly artistic effect.

To attain the above objects, a Christmas tree of the present invention comprises a trunk frame; a plurality of branch supports attached to the trunk frame; and a decorative layer enclosing the branch supports. In an embodiment of the invention, the branch supports are attached to the trunk frame by a plurality of lock members. The decorative layer comprises a plurality of branches and petals connected with the branches.

In the invention, each of the branches and the petals comprises an inner body, a color coating formed on the inner body, an adhesive layer formed on the color coating, and a plurality of transparent plastic grains bonded to the adhesive layer. The branches and petals are made of soft plastic with a predetermined color. Each of the branches and the petals has glitter powder distributed thereon. In another embodiment, the Christmas tree of the invention further comprises a plurality of decorative lamps enwinding on the branches. A plug is provided for electrically connecting with the decorative lamps. The trunk frame comprises a support rod and a base connected with the support rod. The base comprises a plurality of wheels thereon for moving the Christmas tree.

Comparing with the prior art, the Christmas tree of the present invention has a visual effect of crystal ice for its decorative layer. Under light, especially sunshine, ultraviolet ray lamps or other colored lights, the Christmas tree is glittering and translucent. When the Christmas tree is positioned in parlor, hung in house or showed in shopwindow, hall or corridor of restaurants or office buildings, it can attain a surprising visual effect. In addition, the Christmas tree will have a rainbow visual effect under light at night because of glitter powder on the branches and the petals.

For the purpose of making the invention easier to understand, several particular embodiments thereof will now be described with reference to the appended drawings in which:

### DESCRIPTION OF THE DRAWINGS

FIG. 1 is a structural sketch view of a Christmas tree according to a first embodiment of this invention;

FIG. 2 is a sketch view to show a connection relationship of between a trunk frame and branch supports of the Christmas tree in FIG. 1;

FIG. 3 is a structural sketch view of a branch of the Christmas tree in FIG. 1;

FIG. 4 is a structural sketch view of the branch with petals of the Christmas tree in FIG. 1;

FIG. 5 is a structural sketch view of the branch with petals enwinding with decorative lamps of the Christmas tree in FIG. 1;

FIG. 6 is a cross-sectional view of the branch of FIG. 3 according to a first embodiment of the invention;

FIG. 7 is a cross-sectional view of the branch of FIG. 3 according to a second embodiment of the invention.

### DETAILED DESCRIPTION OF THE INVENTION

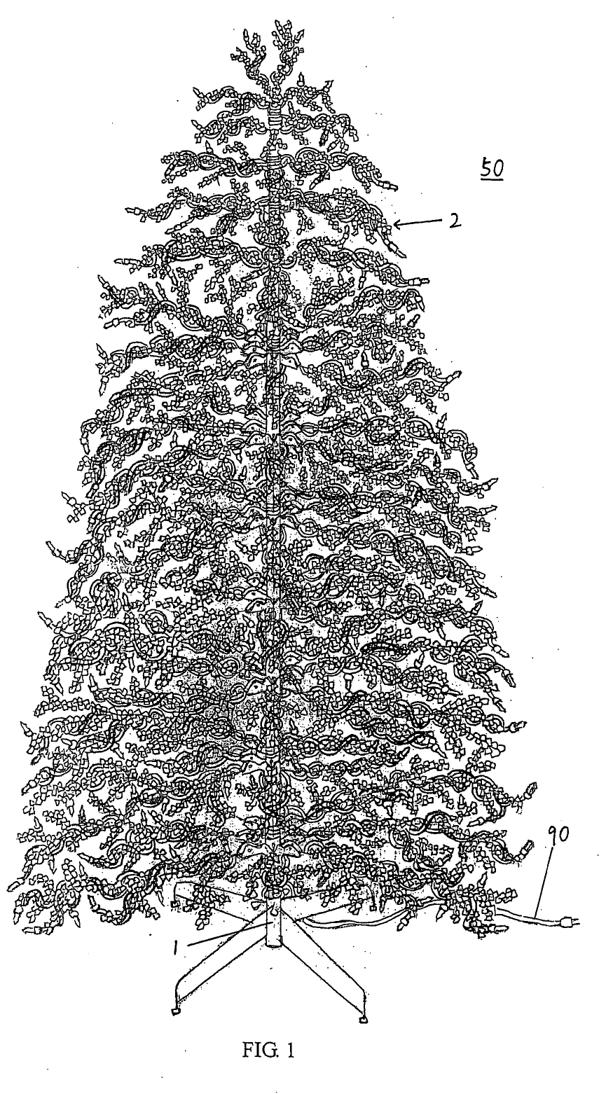

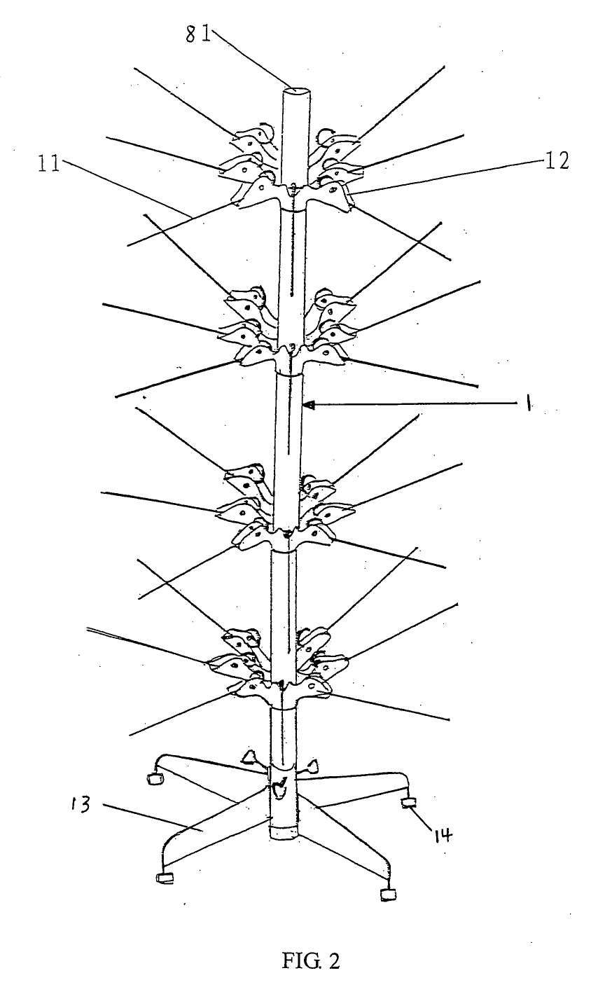

The following will give a detailed description of the invention taken in conjunction with the accompanying drawings. Referring to FIGS. 1-2, according to an embodiment of the invention, a Christmas tree 50 comprises a trunk frame 1, a plurality of branch supports 11 attached to the trunk frame 1, and a decorative layer 2 enclosing the branch supports 11. In another embodiment, also referring to FIG. 2, the branch supports 11 are attached to the trunk frame 1 by a plurality of lock members 12. Referring to FIG. 2, the trunk frame 1 comprises a support rod 81 and a base 13 connected with the support rod 81. In an embodiment, the base 13 may has a plurality of wheels 14 thereon for moving the Christmas tree 50.

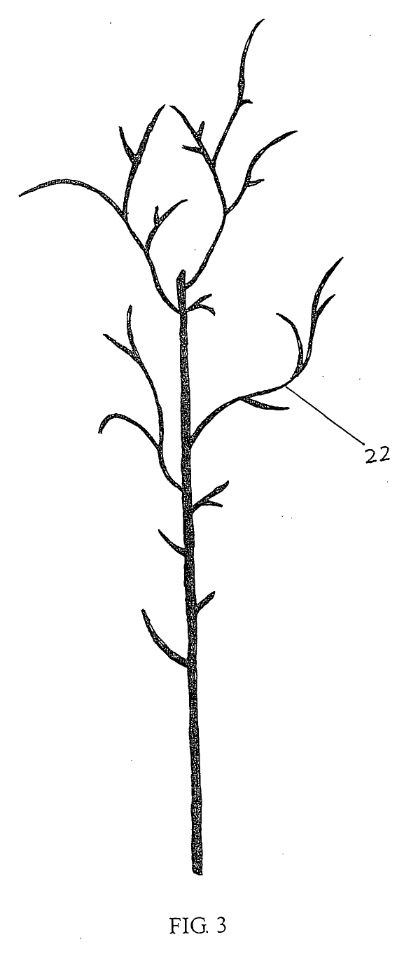

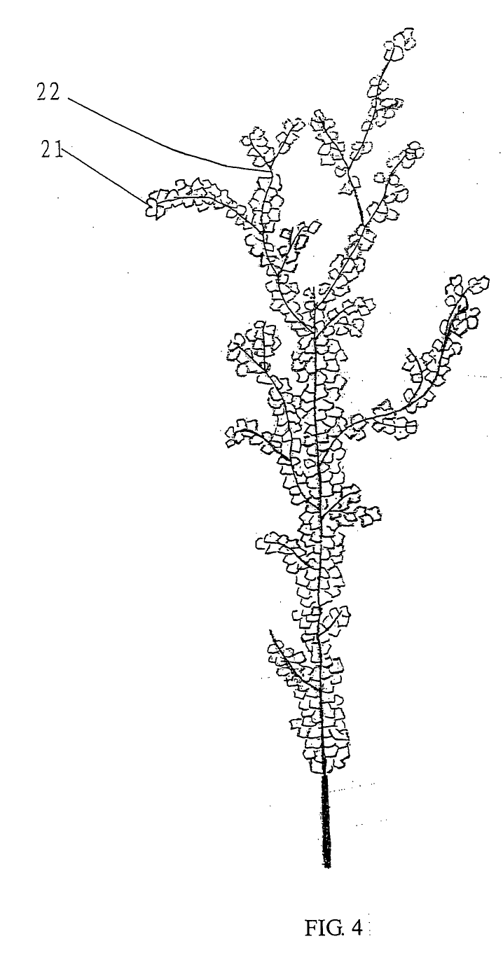

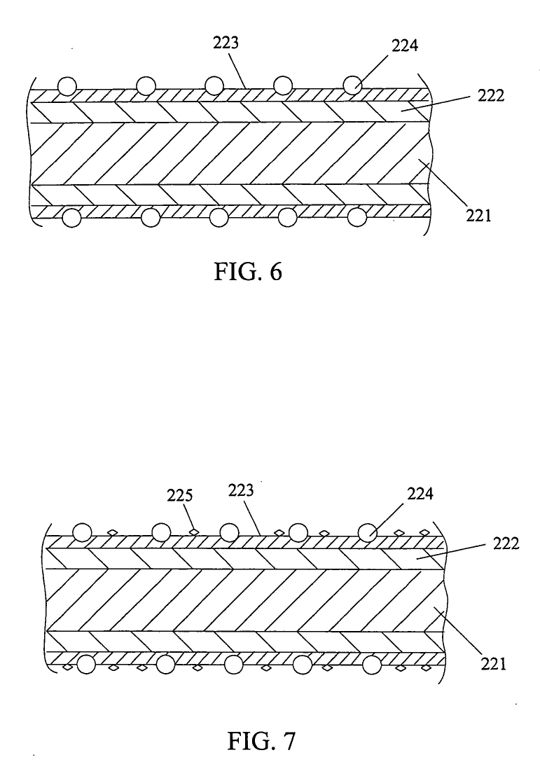

Referring to FIGS. 3-4, the decorative layer 2 comprises a plurality of branches 22 and petals 21 connected with the branches 22. In the invention, referring to FIG. 6, each of the branches 22 comprises an inner body 221, a color coating 222 formed on the inner body 221, an adhesive layer 223 formed on the color coating 222, and a plurality of transparent plastic grains 224 bonded to the adhesive layer 223. Each of the petals 21 has a similar structure to that of the branch 22, thus a detail description thereof is omitted herefrom. In the invention, the branches 22 and petals 21 are preferably made of soft plastic, which can have a predetermined color according to actual circumstances the Christmas tree 50 positioned.

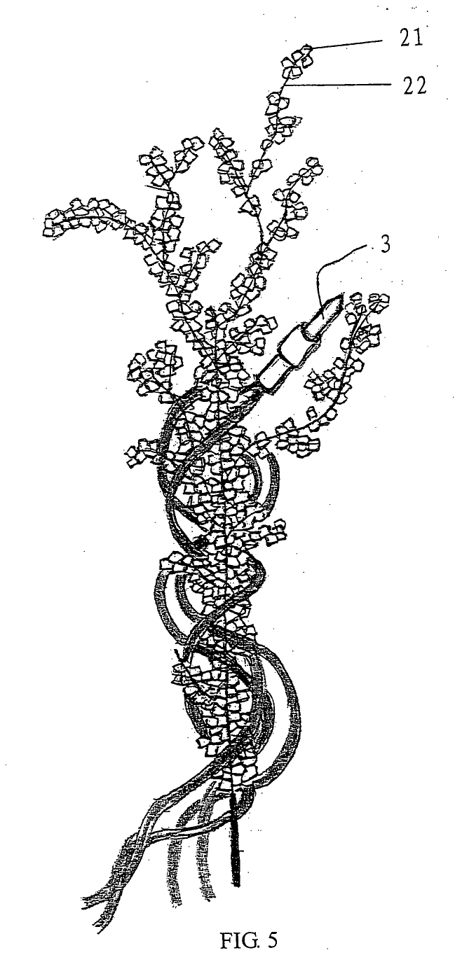

In a further embodiment, referring to FIG. 7, each of the branches 22 and the petals 21 has glitter powder 225 distributed thereon so that the branches 22 and the petals 21 can attain a glitter visual effect under light, such as Christmas light. In an embodiment, referring to FIGS. 1 and 5, the Christmas tree 50 may further comprise a plurality of decorative lamps 3 enwinding on the branches 22, and a plug 90 is electrically connected with the Christmas tree 50 for plugging into a jack so as to input electric current into the decorative lamps 3.

In the present invention, the trunk frame 1 is made of a kind of material with a suitable color corresponding to actual circumstances the Christmas tree 50 positioned. The material has an enough rigidity to support the Christmas tree 50, such as hard plastic, metal, etc. The decorative layer 2 can have a suitable shape according to actual sculpt requirement.

In the present invention, the Christmas tree 50 can be positioned at indoors or outdoors. The color of the Christmas tree 50 can be appeared as a predetermined color according to the color of the trunk frame 1 and the decorative layer 2, such as white, blue, red, green, etc.

It is understood that the invention may be embodied in other forms without departing from the spirit thereof. Thus, the present example and embodiment are to be considered in all respects as illustrative and not restrictive, and the invention is not to be limited to the details given herein.

What is claimed is:

1. A Christmas tree comprising:
a trunk frame;
a plurality of branch supports attached to the trunk frame; and
a decorative layer enclosing the branch supports.

2. The Christmas tree according to claim 1, wherein the branch supports are attached to the trunk frame by a plurality of lock members.

3. The Christmas tree according to the claim 2, wherein the decorative layer comprises a plurality of branches and petals connected with the branches.

4. The Christmas tree according to the claim 3, wherein each of the branches and the petals comprises an inner body, a color coating formed on the inner body, an adhesive layer formed on the color coating, and a plurality of transparent plastic grains bonded to the adhesive layer.

5. The Christmas tree according to the claim 3, wherein the branches and petals are made of soft plastic with a predetermined color.

6. The Christmas tree according to the claim 4, wherein each of the branches and the petals has glitter powder distributed thereon.

7. The Christmas tree according to the claim 6, further comprising a plurality of decorative lamps enwinding on the branches.

8. The Christmas tree according to the claim 7, wherein the trunk frame comprises a support rod and a base connected with the support rod.

9. The Christmas tree according to the claim 8, wherein the base comprises a plurality of wheels thereon for moving the Christmas tree.

10. A Christmas tree comprising:
a trunk frame;
a plurality of branch supports attached to the trunk frame; and
a decorative layer enclosing the branch supports; wherein the branch supports attached to the trunk frame by a plurality of lock members;
the decorative layer comprising a plurality of branches and petals connected with the branches;
each of the branches and the petals comprising an inner body, a color coating formed on the inner body, an adhesive layer formed on the color coating, and a plurality of transparent plastic grains bonded to the adhesive layer.

11. The Christmas tree according to the claim 10, wherein each of the branches and the petals has glitter powder distributed thereon.

12. The Christmas tree according to the claim 11, further comprising a plurality of decorative lamps enwinding on the branches.

13. The Christmas tree according to the claim 12, further comprising a plug electrically connecting with the decorative lamps.
